(19) United States
(12) Patent Application Publication
(10) Pub. No.: US 2015/0142713 A1
(43) Pub. Date: May 21, 2015

(54) Real-Time Adaptive Decision System And Method Using Predictive Modeling

(71) Applicant: Global Analytics, Inc., San Diego, CA (US)

(72) Inventors: Krishna Gopinathan, San Diego, CA (US); Sriram Rangarajan, Chennai (IN)

(21) Appl. No.: 14/531,972

(22) Filed: Nov. 3, 2014

Related U.S. Application Data
(60) Provisional application No. 61/899,808, filed on Nov. 4, 2013.

(51) Int. Cl. G06N 99/00; G06N 5/04

(52) U.S. Cl. CPC G06N 99/005; G06N 5/04
USPC 706/14

(57) ABSTRACT

An apparatus, system and method for automatically evaluating a transaction request are provided. An adaptive modeling platform builds models and deploys them in a very systematic manner, without requiring much or any human intervention. This system ensures an end to end data management; encompassing variable generation, model building and evaluation of the built models, decision logic and strategy design. It guarantees deployment of these predictive models in real time, monitors performance of the portfolio and generates reports & alerts for the same. The system periodically examines the models in production and rebuilds them when their performance falls below a predefined threshold. When the human discretion so permits, the system can be interrupted at any point in time and changes can be made wherever desired in the process. From a business point of view, AMP will significantly reduce the resources and time required for the entire process, starting from raw data to building models and decision logic, to monitoring performance and reconstruction, to deployment of the final strategies.

### PRIORITY CLAIM/RELATED APPLICATION

This applications claims the benefit under 25 USC 119(e) to U.S. Provisional Patent Application Ser. No. 61/899,808 filed on Nov. 4, 2013 and entitled “Real-Time Adaptive Decision System and Method Using Predictive Modeling”, the entirety of which is incorporated herein by reference.

### FIELD

The system described herein relates to the methods and devices useful in automation of data mining, statistical analysis, predictive modeling, real-time learning and optimization techniques. More particularly, embodiments of the present system pertain to the systems, methods, apparatuses that provide decision making support, taking as input the incoming raw data, applying transformations to the data, building meaningful variables, training predictive models, regularly assessing the performance of the system, creating reports, raising alerts and rebuilding models, running tests on defined segments and fine-tuning them, and all of this automated to minimize or in some cases absolutely eliminate human intervention.

### BACKGROUND

The rapidly growing large volumes of a wide variety of data pouring from different sources, carries valuable information that can be economically extracted. These sources include internet data, data from social networks, mobile data, sensor data and big science data. The data can be converted to actionable insights which contribute towards numerous different decision making processes. The size and complexity of data involved in any event that occurs online or otherwise, has been increasing exponentially. If this event demands a decision as an output, to manage the process flow (involving credit or otherwise) with caution and maintain level of confidence while doing so, available data needs to be analyzed using efficient, fast, reliable and intelligent predictive models. Business enterprises and technology systems thus require rapid reactions and decision making processes to keep up with emerging markets. A solution is thus required which has a high volume capability and real time functionality to pull data from multiple dependable sources.

In addition to the accelerating rates at which data is being generated and its complexity increasing, the meaning of this data and its interpretation also changes with time. The relationships among data from different or even same sources keep transforming over time. If new types of data are emerging and the meaning of the data elements and of relationships among elements keeps changing, the system must change as well to accommodate these variations. The existing conventional decision support systems are equipped with the fundamental procedure to carry out an event review, fetch required information and process the request to output a recommendation. However, these systems are not prepared to meet the high demands of the rapidly changing environment. They do not have the provision to pour outcomes into a self learning system, which would adapt and re-write itself according to the most current updated information available.

It is desirable to transition traditional data mining and storage needs into the realms of real-time computing with the efficiency of modern processing systems. It is also desirable to provide quick, efficient, accurate, up-to-date, smart recommendations to interactive channels by combining analytics, business logic and contact strategies.

### BRIEF DESCRIPTION OF THE DRAWINGS

A further understanding of the nature and advantages of the present system and method may be realized by reference to the remaining portions of the specification and the drawings wherein reference numerals are used throughout the drawings to refer to similar components.

FIG. 1 is a block diagram illustrating the process and components of the present system;

FIG. 2 is a flow diagram illustrating the process and components of the Real Time Decision Engine Module of the present system;

FIG. 3 is a flow diagram illustrating the process and components of the Near Real Time Processing Module of the present system;

FIG. 4 is a flow diagram illustrating the process and components of the Variable Generation of the present system;

FIG. 5 is a flow diagram illustrating the process and components of the Model Building Module of the present system;

FIG. 6 is a flow diagram illustrating the process and components of the Model Management Module of the present system;

FIG. 7 is a flow diagram illustrating the process and components of the Champion-Challenger Module of the present system;

FIG. 8 is a flow diagram illustrating the process and components of the Decision Logic Module of the present system.

### DETAILED DESCRIPTION OF ONE OR MORE EMBODIMENTS

The adaptive decision system and method may use heuristic methodology that utilizes predictive modeling techniques like neural networks, applied using a constant feedback cycle to rapidly learn, classify and adapt to changing patterns, as well as making decisions fast enough for use in real-time. Unlike the standard neural network based approach, this model takes into account the sensitivity of parameters for dealing with uncertainty in decision making. Existing systems do not provide real-time adaptive automated modeling based on behavior with minimal operational upkeep. The real-time automated aspect of this system will provide solutions that react instantaneously to events as they occur. The methods used by the system is agnostic to specific modeling approach/methodology, and as such may be applied to any method wherein models are created from data, including new (yet to be invented) methods for creating predictive models from data. The system and methods described are equally valid with any specific modeling method or combination of modeling methods, including boosting algorithms, Bayesian forests and deep learning.

In accordance with an embodiment of the present system, an apparatus, system, and method are disclosed that provide an adaptive, automated neural network setup for model creation and deployment, which continuously learns from its output and re-creates itself whenever required. This platform amalgamates various processes that can essentially build the decision making system of a process or an entire collection of processes (such as required to operate an entire business), including but not limited to variable generation, model building, optimization and fine-tuning, portfolio performance evaluation, report generation and alert triggering mechanisms, decision logic and strategy design, and deployment in a real time system. This platform can be applied to any type of business that uses data from any event requiring a decision as an output, including (but not limited to) consumer credit, business credit, fraud detection, targeted marketing, transaction monitoring, customer care, pricing optimization, and many others.

According to some embodiments of the present system, the design facilitates examination of millions of events for potential outcomes in order to determine the probability of success and decide the fate of the credit involved (if any) therein based on the current business strategy in real time. This system may take into account variables pertinent to the type of transaction, particularly, variables based on economic environment, employment and income, affordability, and the effect that time has on these and other variables related to the subject matter. In addition, in accordance with an embodiment of the present system, a method is provided for creation of meaningful time dependent variables that can be personalized given the nature of event.

In a further embodiment of the present system, a method is provided that may contribute to the generation of Bayesian adjusted digital filters. For example, each time new information is received by the system, it may be consumed by specific processes (that may be implemented as one or more algorithms) to compute updated values for these variables in real time. These processes may be tailored to achieve particular goals. Thus, the output generated from the processes may be reused as input in addition to new data in the next iteration. The current system may employ many transformations to manipulate these variables. These transformations would include but are not limited to regulating the contribution of data towards certain calculations based on time when that data was captured, control the domination of a subset in the calculations pertaining to the entire sample space, etc.

The system may have a sub-system that may extend the platform to generate post-decision analytics, taking into consideration the decision values and all external data related to the event. This sub-system also enables the management and storage of all the data that flows through the system, the input data, and variables created from the raw data, model outputs and computed scores, and decisions. Furthermore, in accordance with an embodiment of the present system, a mechanism may be provided for continuous performance evaluation of the portfolio as a whole in addition to the sub-system processes. This mechanism may monitor the distribution shifts, correlation changes, and other diagnostic measures, triggers alerts whenever necessary for human intervention and generates automated reports.

Ill further embodiments a system is provided for providing dynamic evaluation, re-building and optimizing the underlying mathematical models that intelligently iterate based on the current performance and threshold defined. This sub-system can be further connected to a management module that acts as an alert trigger system targeting the underperforming components and to invite human interaction whenever the automated system goes out of bounds. This sub-system also allows introduction of new improved models and modeling techniques via human intervention. In still further embodiments a system is provided for Implementation, management and adjustment of test strategies relative to the current business strategy.

In yet further embodiments a system is provided that may automatically take in new inputs (models, variables, rules and challenger specifications) and develop an optimized strategy which leads to increased gains in key business metrics and ensures successful deployment of the formulated rules into the production system.

The system may also include a component that rebuilds the models. If one does not take time into consideration and rebuild the model, the data degrades and so does the model performance. In the past with other systems, humans had to sift through the large volumes of data in order to arrive at educated conclusions because bad data (corrupted, incorrect or incomplete) had the potential to degrade the performance the model. These manual methods require intensive human expertise and effort and consume many business resources (including time) which could be spent much more efficiently in other areas.

An embodiment of the present system may utilize various real-time technology components such as workflow systems, knowledge management, data warehousing, data mining, and data analysis and has the ability to make recommendations possible in high volume query environments. The dynamic, (near) optimal, real-time decisions are based on a combination of current and historical data of the subject matter being analyzed for resulting predictive trends. The parameters of those decisions may transition over time, which the model accounts for. Many times, the optimized decision can be made only from predictive values resulting from the trends of analyzed historical data calculations of risk and profits and loss. These decisions are produced from the predictive model, which does not require human interaction.

Traditional systems have only attempted to decrease data latency and have not targeted analysis or action latencies, which have normally been controlled by manual processes. The Adaptive modeling platform (AMP) system is designed to maximize the reduction of data analysis and action latencies. Specifically, this system reduces the time needed to:
collect and store data;
analyze data and transform it into usable information to take action;
react to the information and take action

Other exemplary and more robust methodologies used by this system provide for threshold detection, triggering automated actions, alerts resulting from patterns and trends, and feedback back into the process.

This system can meet the needs of the modern competitive environment of high consumer expectations and demanding customer relationships, while increasing revenue and maximizing operational efficiencies. The various industries requiring technology which has the ability to process and analyze increasing volumes of continuously updated data from multiple sources are, but not limited to telecommunications, networking, logistics, transportation, government. Areas of application for this system include, but are not limited to:
Finance and lending
Data & systems monitoring, validation, security, risk assessment and fraud detection
Customer service call centers
Dynamic pricing and yield management
Payments & cash monitoring
Supply chains
Transportation industry

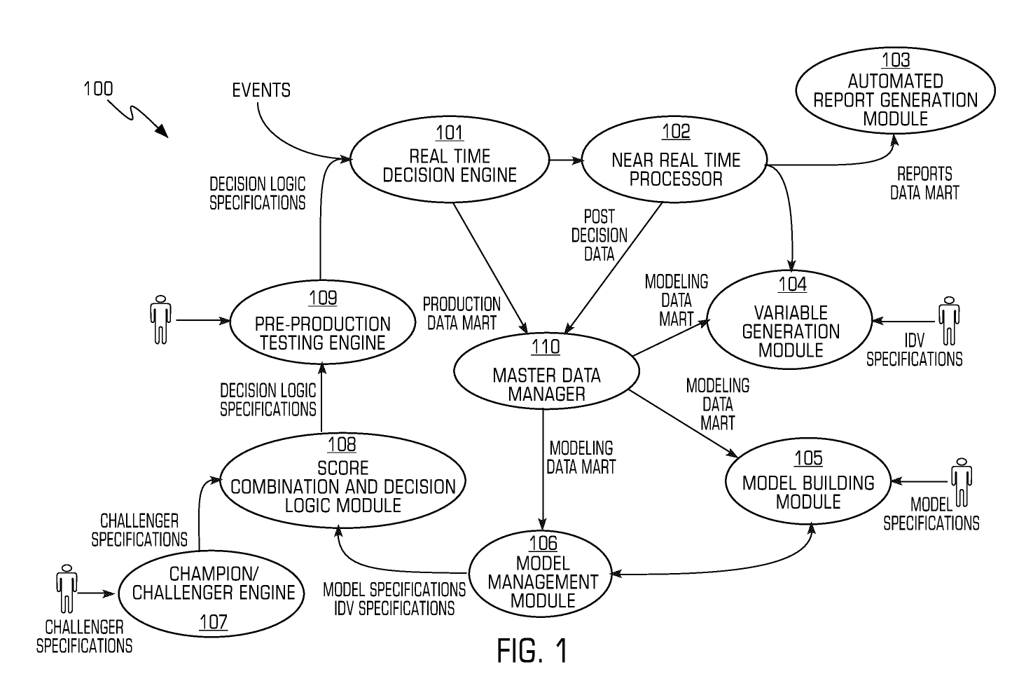

Reference is now made to FIGS. 1-8, which illustrate the processes, methods and components of the system. FIG. 1 illustrates an exemplary process of the present system, an Adaptive Modeling Platform (AMP) 100 and its components. Each component of the AMP 100 may be implemented in hardware, software or a combination of hardware and software. In a hardware implementation of the AMP 100, each component shown in FIG. 1 may be implemented in a hardware device, such as a field programmable device, a programmable hardware device or a processor. In a software implementation of the AMP 100, each component shown in FIG. 1 may be implemented as a plurality lines of computer code that may be stored on a computer readable medium, such as a CD, DVD, flash memory, persistent storage device, cloud computing storage and then may be executed by a processor. In a combination of hardware and software implementation of the AMP 100, each component shown in FIG. 1 may be implemented as a plurality lines of computer code stored in a memory and executed by a processor of a computer system that hosts the AMP 100 wherein the computer system may be a standalone computer, a server computer, a personal computer, a tablet computer, a smartphone device, a cloud computing resources computer system and the like.

The AMP 100 may comprise a Real Time Decision Engine 101 that may deploy one or more predictive models and decision strategy of the AMP 100. The Real Time Decision Engine 101 may take in raw data, create variables and compute model scores, and based on the current business strategy may provide a real time decision. The variables thus created and the final decisions made may be stored in a Master Data Manager 110, at all times.

In the case of a loan application, the incoming raw data may be the data that the applicant provides which includes (but is not limited to) his/her identity information, bank account details and debit/credit card details. This raw data may be processed and transformed, creating bin and flag variables, among other mathematical operations and transformations. The data thus generated may be input into the modeling suite, where each model produces a score which might be a predictor of probability of this application getting approved, measure of credit risk involved or fraud, etc. Data may also be fetched from third party providers and credit bureaus. A real time decision which includes rejection of loan to the applicant, further processing or immediate approval may be involved. For example, let the input data constitutes of the following variables (among other data):

1. first name (say John),

2. last name (say Taylor),

3. monthly income (say $2000) and

4. bank account number.

The data may also be fetched from third parties, which may include (but is not limited to) credit scores, presence on electoral rolls, any records of bankruptcy, etc. This data is subjected to transformations that convert it into processed information for the purpose of extracting maximal predictive power. Some examples of transformations on income variable may include (but are not limited to):
a flag if the income is less than say $100;
a flag on the bank account number, 1 if the same account number was used by another customer before, 0 otherwise;
binning on income—where bin 1 may have all customers with income >$4000, bin 2 may have all customers between $4000 and $1000 band and bin 3 may have customers with income <$1000.

In the above example, John, gets the value of flag variable on income=0, value of flag variable on bank account number=0 and falls in income bin 2. In this example, the lending decision may be based on one of the third party credit scores, flag variable on bank account number and profit model scores built by the system. The flag variable on bank account number acts as a fraud alert, triggering when the same bank account number is seen for a different customer. Such a customer may not get rejected, but may be treated with caution. Let the raw and derived variables be given as input to a model that predicts profit. If the combination of the two scores and the flag on bank account number does not pass the predetermined threshold, the customer may be either rejected or evaluated further. Given the fraud alert is not triggered, let John gets a high profit score but a low third party credit score and the combination does not pass the threshold of the decision logic in place, he is subjected to further analysis. This decision is recorded by the system.

The system also may include a Near Real Time Processor 102 that may capture post decision data and applies transformations to it. In a lending environment, the post decision data may include (but is not limited to) data collected on customer surveys and call center conversations. Some lenders may collect additional data after a provisional decision is provided to the customer. This additional data may include (but is not limited to) data captured from bank statements, utility bills, employer data, etc. For example, a user, John, may be asked for his bank statement or pay slips, via customer care center that may be used to confirm his monthly income and thus establish trust in the customer.

The data from the Near Real Time Processor 102 may be synced to a Master Data Manager 110. This data is used as an input to the models. Since the data is always fetched from the Master Data Manager whenever a new model is build or an existing one is rebuilt, or the performance of a certain business metric has to be evaluated, this data needs to be synced into the Data Manager. The Master Data Manager 110 may be a master repository of all system data. The system also may have an Automated Report Generation Module 103 that takes data from Master Data Manager 110, and applies trigger alerts and distribution shift alarms along with reports on the performance of key business metrics. In a lending environment, for example, there is some expected minimum number of applications for loans, percentage of approvals, maximum risk cutoffs, fraud thresholds, etc that should be satisfied. If any of these are not met, an alert is triggered by this system to notify for human intervention.

The AMP 100 also may include a Variable Generation Module 104 that maintains variables by computing them from the transactional data and also handles creation of new variables from the transactional data using specifications provided by human input. The specifications in case of a lending business may include (but are not limited to) building flags, bins, and mathematical and logical transformations of raw data to extract more valuable information out of the available data, which can be input into the modeling module. As in the above example, flag and bin transformations are performed on the income and bank account number data obtained from a user's loan application. The data created and used here may be synchronized with the Master Data Manager 110. The AMP 100 also may include a Model Building Module 105 that may automatically build predictive models as per the specifications from an external human source. It also re-builds models that have been previously deployed, as and when triggered by a Model Management Module 106. Specifications in case of a lending business will include (but are not limited to) percentages of data to be considered in the development sample, modeling techniques to be used and other restrictions/conditions that the data should follow/satisfy. The performance of the existing models may deteriorate with time and it may not validate as well on the incoming data as it did on the training data. This system will allow for the re-build of models at regular, alert triggered or human initiated intervals. For example, when an initial profit model (say M1) from the above example was built, the number of transactions used as input was 10. Now, with the lending business running, the number of transactions has increased to say 100 and thus a second version of the profit model (say M2) may be built. When John's application is received, let M1 predicts his profit to be $100 and M2 predicts his profit to be $110. Actual profit generated by John is $109. Since M2 produces better estimates of the derived variable, this new improved model would be incorporated into the lending business.

The Model Management Module 106 may constantly monitor the performance levels of the models and business metrics with each new transaction. A (new) transaction or event may be a request or an exchange or transfer of a tangible product or service for an asset/money/payment/promise of payment between one or more parties, for example a loan application from a customer to a lender, loan acceptance by lender, transfer of money. Another example may be a credit/debit card transaction for purchase of goods, acceptance of customer details by the retailer and delivery of the purchased entity. If the performance of any of the deployed models or business metrics falls below a predefined threshold, it sends a request to the Model Building Module 105 to rebuild the underperforming model(s) or to a Decision Logic Module 108 to improve the corresponding decision logic. For example, in a lending business, a lending decision may be made by making use of a set of models. The repayment behavior of the borrowers from latest vintages may be compared with the predictions of the models and if the performance parameters show a drop from estimated values, then the Model Management Module may trigger a request to the Model Building Module to rebuild models that are underperforming. The decision logic might depend upon the underperforming models or be affected directly by the new data. The decision logic may be modified to make the threshold fit into the expected values.

In the above lending example, where the profit model was rebuilt, the evaluation of performance of the models and trigger for the rebuild is given by the Model Management Module. The decision logic may also be revisited to check for any scope of optimization. With a modification of the models and other business rules, the system may generate a completely different score combination and decision logic. In this case, since only one model is considered, for the sake of simplicity let model M2 replaces model M1. The decision logic (comprising of the profit model score, a third party credit score and a fraud rule) is altered accordingly and the new thresholds are computed. Both the Model Building Module 105 and Model Management Module 106 use data from the Master Data Manager 110.

The AMP 100 also may have a Champion/Challenger Engine 107 that may evaluate the performance of the various tests that are run on different segments of the portfolio and along with the Model Management Module 106, forms the core of the system which determines what needs to go into the business decision strategy for the Real Time Decision Engine 101. In a lending business, from time to time, new models may be built, improved strategies and algorithms may be developed, third party services may get updated and improved versions may have to be put into use for better results and more accurate estimates. In such cases, a test may be performed on a small sample of the incoming applications and performance of this new service/data may thus be evaluated. When this is done using the Champion/Challenger Engine 107, all optimizations ranging from the percentages that may go into production for this test and if the test is successful are used to determine performance so that automatic deployment of this new service/data to entire incoming volume may require minimum or no human interaction. For example, if a third party whose credit score is being used in the decision logic (in the above lending example) releases a new version of its credit data, before incorporating the new version, the lender may want to test its performance on a small percentage of his portfolio. Given a few specifications, this is handled automatically by the system. The system may test the new version, compare its performance with the old version and generate an optimized strategy.

The AMP 100 may further include a Score Combination and Decision Logic Module 108 that may combine each of the model scores into decision rules and undertakes a thorough profit optimization and gives a final verdict as to whether each particular rule should be deployed into the Real Time Decision Engine 101 or discarded. In a lending environment, the decision of whether an application for loan should be approved may depend upon multiple factors including (but not limited to) probability of conversion, risk estimates, fraudulent intent, profit analysis. Each of these factors may be computed using various models and model scores may be seen in conjunction to arrive at the final decision of whether an application should be rejected or approved. The Score Combination and Decision Logic Module may put together these tasks of combining scores from various models and decision strategies, and their deployment.

The AMP 100 also may have a Pre-production Testing Engine 109. Thus, before deployment of the variables, models and decision logic, the Pre-production Testing Engine 109 may act as a staging environment to test and identify any issues with the prospective deployment into the real time decision system. After testing is completed within Pre-Production Testing Engine 109, the decision logic specifications obtained as an end result of computation by Score Combination and Decision Logic Module 108 along with the corresponding predictive model, challenger and variable specifications, are deployed into the Real Time Decision Engine 101, completing the feedback cycle. The cycle usually repeats when sufficient new data is available. In some embodiments, the cycle repeats with each new transaction. In the AMP 100 shown in FIG. 1, each module's internal operations and structure are independent from other modules, allowing each to be developed independently without affecting the overall system performance, functionality or design.

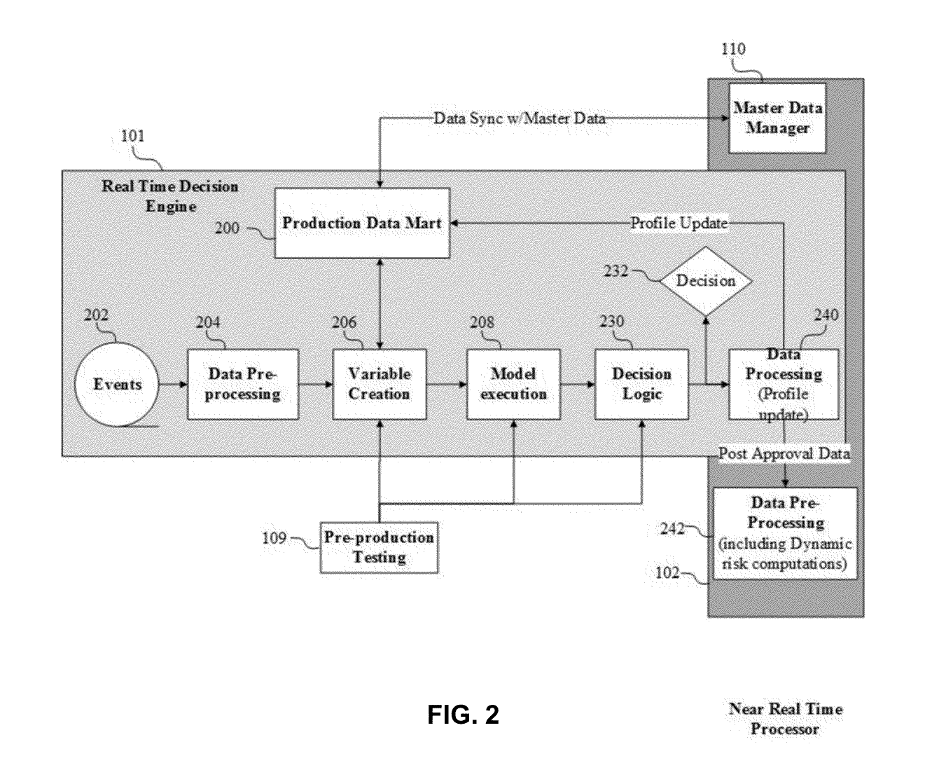

FIG. 2 illustrates more details of the Real Time Decision Engine 101 of the AMP 100. In one implementation, each of the modules of the Real Time Decision Engine 101 may be a plurality of lines of computer code that are stored in a memory of the computer system that is hosting the AMP 100 and executed by a processor of the computer system that is hosting the AMP 100. The Real Time Decision Engine 101 executes the current business strategy in real time. For example, this engine 101 may continuously process the incoming transaction requests, obtained as Events 202, creates useful variables as per the specifications stored in Variable Creation module 206 and evaluates the Events based on the current decision logic as saved in Model Execution module 230, and Decision Logic module 230, and makes recommendations which are reported as a Decision 232 in real time. In this process, the data generated may be comprehensively recorded and stored in a Production Data Mart 200. This data may be transferred continuously to the Near Real Time Processor 102 and gets stored permanently in the Master Data manager 110. The architecture of this system is designed specifically for automatic deployment of business strategies. In a lending business, the data collected on any loan application may be subjected to the rules and strategies that are currently deployed in real time. These rules that are used to provide a final decision may comprise of the variable transformations, risk models and other decision strategies. The decision may be recorded permanently. In the above lending example, John's application for loan is evaluated using a profit model score, a third party credit score and a fraud alert.

The Pre-processing Testing module 109 of the AMP 100 shown in FIG. 1 may supply the Variable Creation module 206, the Model Execution module 208 and the Decision Logic module 230 with specifications. The specifications may include conditions, logical and mathematical transformations to create flags, bins and other derived variables from the raw data obtained as a part of the application. Another set of specifications may include (but is not limited to) percentage splits of data for the training and validation samples, modeling techniques. Yet another specification may contain all the information for final deployment, which may include (but is not limited to) the score combinations, profit optimization conditions for tests and their expansion.

The Events 202 may be a stream of incoming transactions on which the decision strategies (typically created using predictive models) are applied and a decision is made (usually in real time). Each event may be provided to the system in xml feeds (although each event may be provided in other formats and data formats that are within the scope of the disclosure) and may consist, for example, of application data, third party data, post decision data or simply data triggered by passage of time. In an embodiment of the system used for consumer credit, each Event 202 may be an incoming loan application with each one referred to as a single transaction. The Real Time Decision Engine 101 provides a decision during each transaction to either approve or decline credit. In an embodiment of the system used for fraud detection, Events 202 typically corresponds to credit or debit card transactions. The Real Time Decision Engine 101 then performs its processes to classify a given transaction as fraudulent or not.

Each event is captured in the Data Pre-processing module 204. The variables may be created using this information along with data received from the Production Data Mart 200, as per the specifications in Variable Creation module 206. The Real Time Decision Engine 101 may have a Production Data Mart 200 that may send as well as receive input from the Master Data Manager 110 (part of the Near Real Time Processor 102). The variables resulting from the output are fed into the Model Execution module 208 and the execution of the decision logic 230 triggers a process that will use the various variables and models computed which decide the fate of any given transaction—e.g., in case of a lending business, the decision could be whether to approve the loan application or reject it. It also triggers a data process that will update the various profiles and other tables to reflect the processing of this current lead. For the lending example mentioned above, this module may operate by taking in data as input from the transaction (first name, last name, monthly income, bank account number, third party data), cleaning up and building derived variables on this raw data to extract more value (flag and bin variables on income and bank account data), building models and computing model scores (profit model), and providing the decision as to whether an application is approved or not.

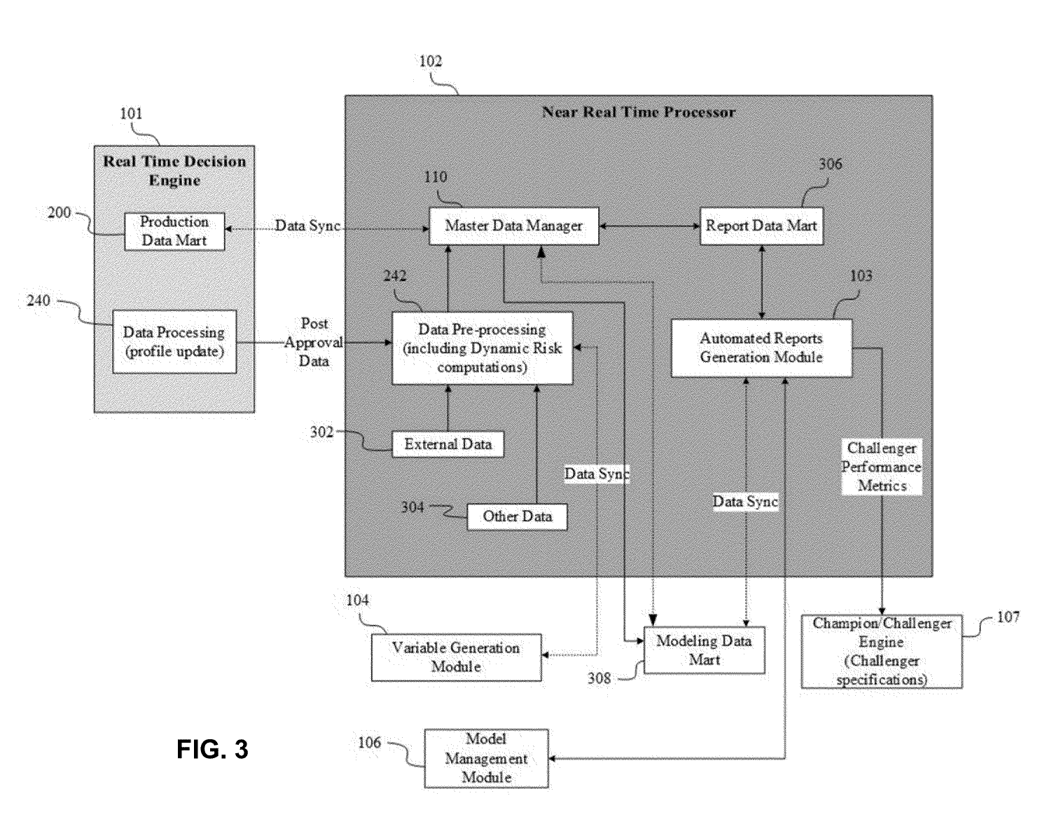

FIG. 3 illustrates more details of the Near Real Time Processor 102 of the AMP 100. The Near Real Time Processor 102 may continuously receive the data from the Real Time Decision Engine 101 which it organizes and stores in a repository, referred to as the Master Data Manager 110. The Near Real Time Processor 102 may also receive data from various other sources—both periodically and asynchronously. Other sources may include (but are not limited to) external data provider, input from another data source from within the organization, example marketing campaign and survey results, among many others. The Near Real Time Processor 102 may constantly prepare the data for future modeling activity, which it stores in a Modeling Data Mart 308. Using the specification as forwarded from the Variable Generation Module 104, the Near Real Time Processor 102 may create various transformed data fields and stores the values assigned in Master Data Manager 110. Examples of transformed fields may include (but are not limited to) flags on various values, decile binning on these values, other logical and mathematical transformations on the raw incoming data fields. In the lending example considered above, flag and bin transformations are performed on income and bank account data. These transformations may be performed so as to convert data into a suitable format to extract maximum information that could be fed into the Modeling Module for building the models.

In the Near Real Time Processor 102, offline decision outcomes data 304, and data from other additional external sources 302, enters a Data Pre-Processing module 242, where complex variable computations, which include (but are not limited to) dynamic risk computations, etc, are carried out. External sources may include (but are not limited to) data collected from social networks, etc. The data then may be synched with the information received from the Variable Generation Module 104, which contains dependent variables (DVs) and independent variables (IDVs) in the form of definitions, exclusions, missing value treatment, segmentation, maturity conditions, and sampling parameters. A Data Processing module 240, part of the Real Time Decision Engine 101, updates various profiles which become a part of the input data and provides Post-Approval data which is also fed into the Data Pre-Processing 242. Using the data from these sources, it computes transformations of these data based on the specifications in the Independent Variable specifications (IDV.spec) file. The various profile variables and tables are updated as part of this processing and this data is stored permanently in the Master Data Manager 110.

The Near Real Time Processor 102 may also enable the generation of various types of reports on a continuous basis in a Reports Data Mart 306. The Master data Manager 110 provides data to the Automated Reports Generation Module 103 which computes various business performance metrics concerning, but not limited to profit, bad debt, acquisition, model performance, champion/challenger performance. In the system, alarms and alerts are triggered based on the comparative analysis against data from a previous day, previous month, previous year, previous market conditions or any such conditions specified. This module constantly measures correlations between different independent variables, correlation between independent variables and dependent variables, applies the Kolmogorov-Smirnov statistical distribution test across all variables to identify significant distributional shifts over various time intervals, and monitors other such diagnostic metrics. If an anomaly is found, this module automatically triggers corrective action invoking the Model Management Module 106 (which then triggers model rebuilds for affected variables). A case is also flagged for human intervention. The human operator may interfere whenever he/she so desires. This module also sends to and receives data from the Modeling Data Mart 308.

In an embodiment of the AMP system 100 used for consumer credit, the pre-decision data retrieved by Real Time Decision Engine 101 usually includes (but is not limited to) consumer's loan application data covering their income among other details as well as any external credit bureau data (covering an applicant's customer history). The post decision data (retrieved from Near Real Time Processor 102) can include an applicant's reaction to the decision, take-up status of the offer, and more. Outcomes data 304 in this embodiment generally consists of performance of previous loans in the portfolio. The Automated Reports Generation Module 103 covers portfolio performance metrics like profit, bad debt, conversion and more. All the data is consolidated by the Master Data Manager 110 and made available to other modules.

In an embodiment of the AMP system used for fraud detection, pre-decision data can typically include (but not limited to) transaction details like the card transaction amount, geographic details, merchant details and more. Outcomes data 304 in this embodiment typically consists of known fraud/not fraud states of previous transactions processes by the system. External sources may also have consolidated data on known fraudulent transactions. All the data is consolidated by the Master Data Manager 110 and made available to other modules.

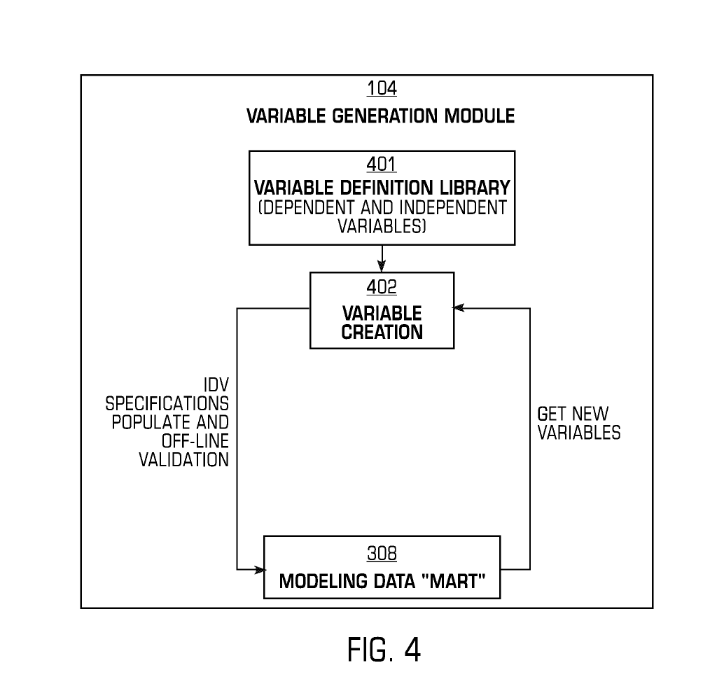

FIG. 4 illustrates more details of the Variable Generation Module 104 of the AMP. This module enables creation of variables—data transformations that convert raw data into useful information and lend insights pertaining to the transaction in question. The Variable Generation Module 104 may have a Variable Creation module 402 that relies on the specifications received from Variable Definition Library 401 (which may have human interaction and input) as well as the Modeling Data Mart 308, for the generation of new variables. A part of the business strategy that is present in the Real Time Decision Engine 101 is in the language of these variables—i.e., the business strategy are specified as mathematical and logical functions of these variables and predictive models. This module applies a variable creation process that enables a variable created here to be implemented (if required) in Real Time Decision Engine 101 with no additional implementation work. This removal of potential additional work allows for automating the modeling, decision process and consequently, the entire cycle itself. This module also enables addition of transformations to the existing data generation processes within the Near Real Time Decision Engine 102. The Variable Generation Module also enables offline validation of the Modeling Data Mart 308. This module can be interrupted and fed with external data and definitions by a human operator, whenever desired.

The variable generation module 104 also may be responsible for creating a special class of variables that may be computed by applying Bayesian adjustments to Digital filter functions (referred to in this document as Bayesian adjusted Digital Filters). These variables are usually computed on specific entities, which together represent the data. An entity can be any of (but not limited to) the following: consumer, applicant, bank, state, city, postal code, IP address, and in general, any defined classification of data can be an entity. In an embodiment of the AMP system, the Bayesian adjusted digital filters are computed in the following manner: Let Eᵢ (i=1, 2, 3, . . . ), and t, (I=1, 2, 3, . . . ) denote a series of events, E (and their corresponding timestamps, t) representing an entity, present in the data (for example: if the entity is a bank, these events could be historical loan applications involving customers who have accounts with that particular bank). Let DF(E) be a digital filter function applied to the entity.

For events (E1, E2, . . . , En) and timestamps (t1, t2, . . . , tn) where t is the current time:

$$D F ( E ) = \frac{{\sum }_{1}^{n} f ( Ei ) * {2}^{- λ ( t - ti )}}{{\sum }_{1}^{n} {2}^{- λ ( t - ti )}}$$

where f(Eᵢ) is an objective function computed on each event (e.g.: f(Eᵢ) could represent current status of the loan application Eᵢ), and λ is a positive constant, representing the “half-life” of the digital filter function. The Bayesian adjusted digital filter is computed, for example, by modifying the digital filter function with Bayesian prior estimates:

$$B D F ( E ) = \frac{k * ( prior estimate of f ( E ) ) + {\sum }_{1}^{n} f ( Ei ) * {2}^{- λ ( t - ti )}}{k + {\sum }_{1}^{n} {2}^{- λ ( t - ti )}}$$

k is referred to as the Bayesian constant, and typically takes a positive integer value. The prior estimate is typically computed from other instances of entities in the data (eg: in the case where the entity is a bank, the prior estimate can be computed from the data comprising of the loan applications covering the set of all banks). Other ways of getting the prior estimate include (but are not limited to) computing the average from all data and computing the average from subset of data comprising of preselected entities. The prior estimate can also be computed as a digital filter function applied to the entity class (eg: if the entity is a bank, the prior estimate can be a digital filter function on loan applications covering a subset of banks).

Multiple types of entities can be combined to compute second (and higher) order Bayesian adjusted digital filters. In this case, the prior estimate for each entity can come from its corresponding class in the data (eg: entity can be a combination of bank and postal code, where the prior estimate for the bank is computed from loan application data covering a subset of banks and the prior estimate for postal code is computed from loan application data covering a subset of postal codes).

The objective function used in these variables can also be a function of “outcome” data. These include, but are not restricted to, loan outcomes, fraud, income from loan, profitability, cross sell, conversion, propensity to reactivate, tenure of relationship, sale price (of products), revenue and so on. In these instances, the variables act as (near) real time feedback inputs for the predictive models (and the AMP system in general).

In an embodiment of the AMP system used for consumer credit, the Variable Generation Module 104 maintains the library of variables used as inputs for modeling risk, profitability, conversion, among other metrics. For example, the variables may include (but are not limited to) raw and derived variables from credit history data and identity data of the applicant. In an embodiment of the AMP system used for Fraud detection, the Variable Generation Module 104 maintains the library of variables used as inputs for building fraud detection models, and to simulate business impact due to fraud (before and after improved detection). Examples of variables used for fraud detection may include (but are not limited to) frequency variable on debit/credit card, postcode, bank account number, IP address and device identity variables.

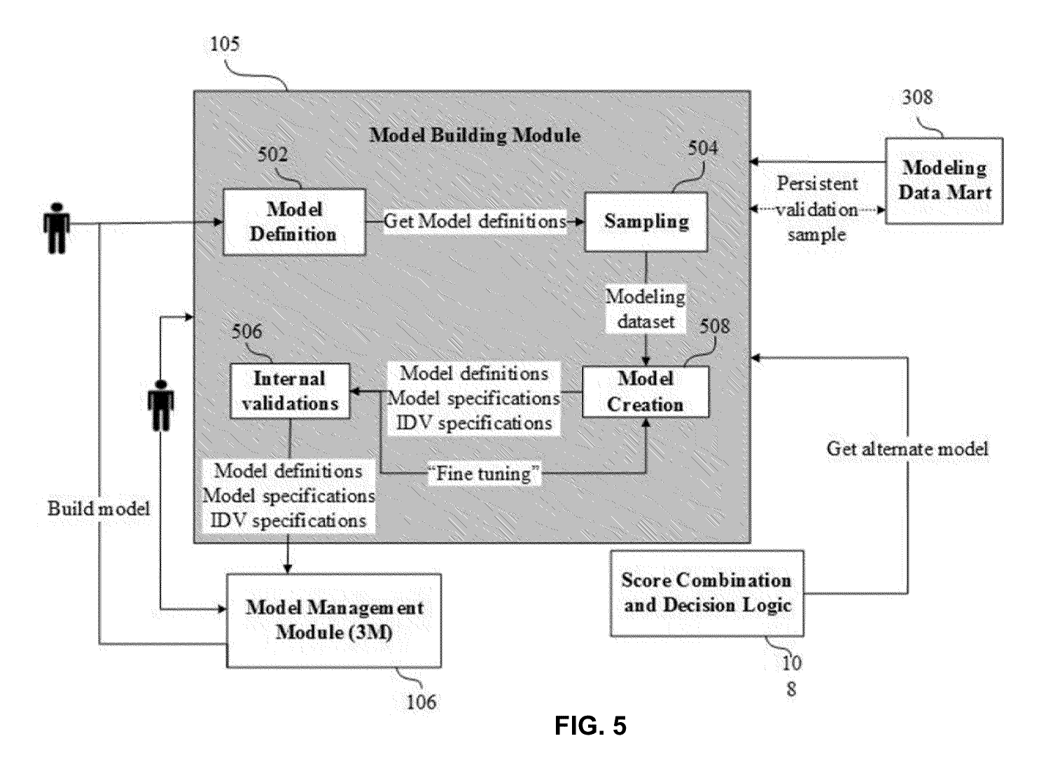

FIG. 5 illustrates more details of the Model Building Module 105 of the AMP. This module may build various types of predictive models which will subsequently be used as primary inputs for business decision making. The Model Building Module 105 may have a Model Definition 502 includes specifications about entity, timeline, DV, sampling, exclusions, segmentations, constraints and validations. The model build can be triggered by the Model Management Module 106 as well as by a human operator. The process involves usage of historical transaction data—taken from the Modeling Data Mart 308. This data feeds a sampling portion 504 of the module, which includes development and validation sample specifications, model definition and provides the dataset for a Model Creation 508. A persistent validation sample is created and maintained through constant data exchange between the Modeling Data Mart 308 and the Sampling element 504. The various modeling techniques used by this system include, but are not limited to, Regression, Neural networks, SVM, CART, Residual modeling, Bayesian forest, Random forest, Deep learning, Ensemble modeling, and Boosting trees. The models created on various data are then pushed into Internal Validations 506 which evaluates the models on independent data reserved for validation, using significance tests and other standard performance metrics. Based on the results of the validations and tests done, the models are adjusted and fine-tuned by model creation 508, working in coordination with Internal Validations 506. This significantly reduces the analyst's time spent building predictive models and lets him/her use the time in generating valuable business interpretations. New, and yet to be developed predictive modeling methods, can be incorporated into the Model Building Module 105 without affecting the behavior of the rest of the AMP system.

In an embodiment of the AMP system used for consumer credit, the Model Building Module 105 is used to build key predictive models on important dependent variables including (but not limited to) risk, conversion, income, profitability, take-up, fraud and identity, term; where each of the dependent variables can have multiple instances (usually based on timeline). In an embodiment of the AMP system used for fraud detection, the Model Building Module 105 is used to build predictive models on several variations of the fraud/not fraud transactional dependent variable. These models, when applied to a lending environment, may predict if a transaction is likely to go through with approval, if it will be higher in risk, be profitable or fraudulent in nature. In the lending example for evaluating John's loan application, the profit model is built to estimate profit earned from each transaction.

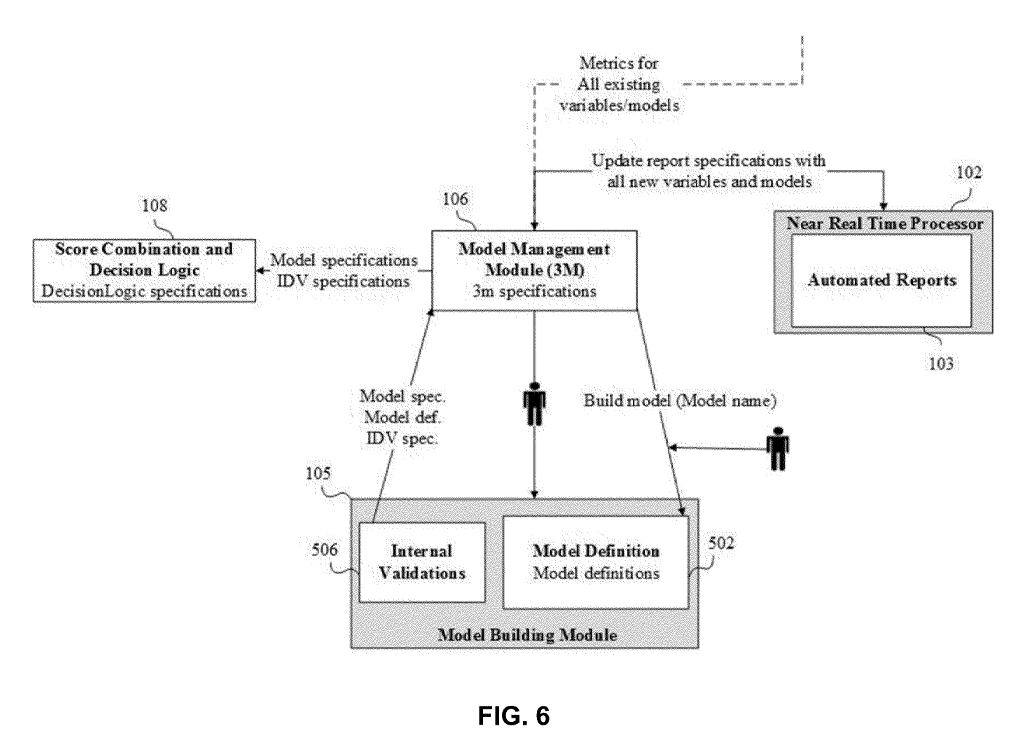

FIG. 6 illustrates more details of the Model Management Module 106 of the AMP. This module is the component that enables the real time adaptive nature of the AMP system. It acts like a workflow manager. Specifically, the Model Management Module 106 receives the model definitions 502 and specifications, as well as the IDV specifications from the internal validations 506 (part of the Model Building Module 105). Human interaction could be introduced to facilitate tasks between the Model Management Module 106 and the Model Building Module 105. The Model Management Module 106 may also synchronize the model score data, for offline validations, with the Modeling Data Mart and sends updated specifications with the new models and variables to the Automated Reports Generation Module 103 (part of the Near Real Time Module 102), which returns the metrics for all existing variables/models. The Model Management Module 106 may also continuously monitor the performance of the business strategy currently deployed and if the performance falls below a pre-specified threshold, automatically triggers rebuilds of the predictive models involved in the underperforming strategy. The Model Management Module 106 may also trigger rebuilding of models on a periodic basis (based on time elapsed or number of transactions processed or a combination of both). In addition, other pre-specified conditions that can lead to rebuilds include (but not limited to) new variables in Master data Manager 110, distribution shift trigger from Automated Reports Generation Module 203, Champion/Challenger trigger from the Champion/Challenger module, and Decision logic trigger from Decision Logic Module 108. The models that are deployed in the Real Time Decision Engine 101 can be set to be rebuilt every day (or even every hour/minute, depending on the business) and adapt dynamically to the ever changing environment. In a lending environment, the models in place may predict risk involved in a transaction. Marketing associated with the incoming traffic might change, resulting in a different behavior of the applicants from the one predicted by the risk model. If this model is built again using data from recent transactions, it should take into account the bias caused by the marketing campaign and predict risk more accurately henceforth. In the lending example where John's loan application is evaluated, the newly built profit model (M2) is able to predict profit more accurately than the first profit model (M1) which was built on lesser data. The Model Management Module 106 also may be able to identify the part of the strategy (model/set of models) that is under-performing and triggers an alert to the Model Building Module 105 to start a rebuilding process for the corresponding models.

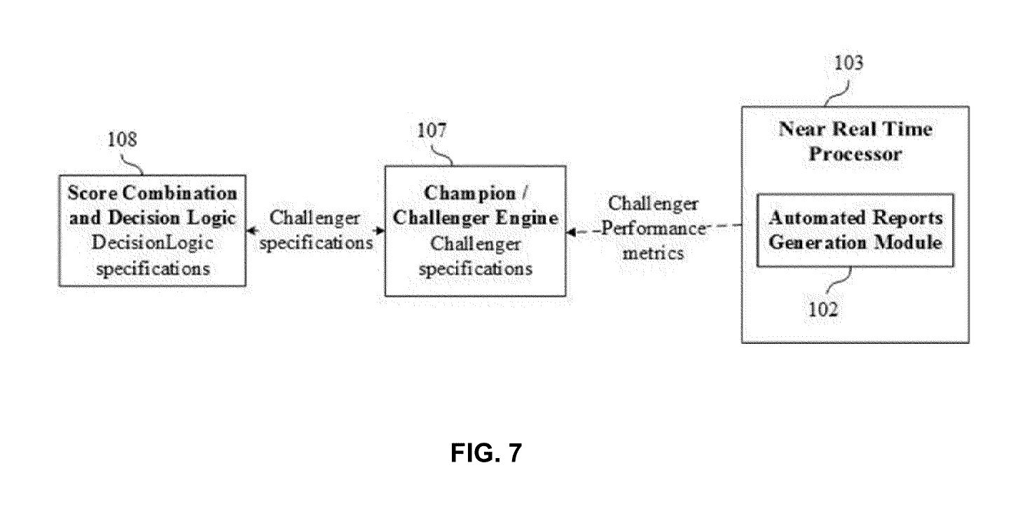

FIG. 7 illustrates more details of the Champion-Challenger Engine 107 of the AMP. This engine is fed with data received from the Automated Reports Generation module 103 (part of the Near Real Time Processor 102) and evaluates performance of challenger segments, recommends optimal expansions and offers new challenger definitions. A challenger typically consists of a decision or choice that modifies the current core business strategy (referred to as the champion). In a lending business, the approval or rejection decision may be provided based on a certain business strategy which is called the champion. If this lender builds a new model or integrates with a new third party data/service provider, the lender may want to test these new models, etc. on a small segment of the incoming transactions. This test would be referred to as a challenger. If the test segment has lower risk and is profitable, the percentage of the incoming traffic on which this test was running, will be increased, if optimal to 100%. The performance of the test segment and entire dataset is checked on various metrics and using different percentage distributions for the challenger segment. The most optimal in terms of risk, profitability, etc is implemented. For example, considering the system evaluating John's loan application where the decision logic depends upon a third party score, which gets updated. The lender tests this new updated score on say 10% of the incoming transactions. If this 10% is performing better than the rest of the portfolio, this percentage is increased, if optimal to a 100%.

The Champion-Challenger Engine 107 may also enable the manual specification for challenger segments. These alternate strategies (the challenger segments) are tried on a random subset of the business transactions and their performance rated against the current champion business strategy. This module automatically adjusts the subset percentages based on performance of the implemented challenger. This module also may evaluate how the predictive models perform in the different challenger segments, and generates rebuild triggers for the model management module if the performance falls below expected or specified thresholds. After a sufficient number of transactions (varies by business product and specific challenger being tested), a successful challenger strategy becomes a part of the current business strategy in production; else it is either modified further or flagged for human intervention.

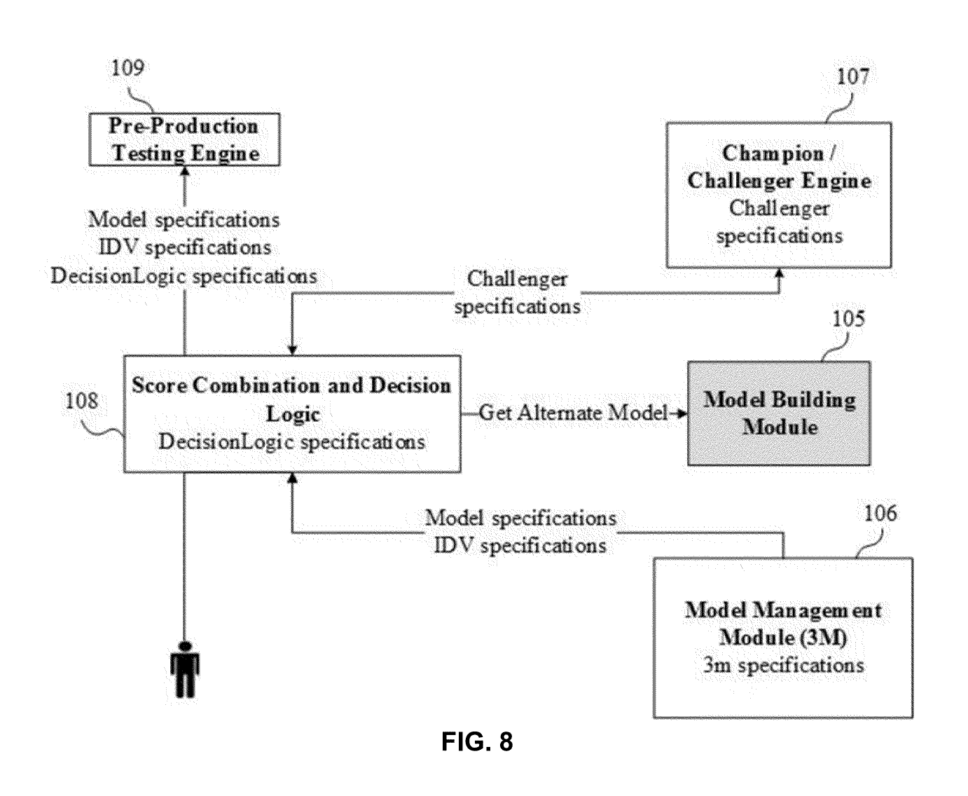

FIG. 8 illustrates more details of the Decision Logic Module 108 of the AMP. This module takes in the predictive models developed by the Model Management Module 106 and evaluates their value addition to the business. The value addition may be ascertained by measuring increase or decrease in various metrics. For example, in a lending environment, the value addition would be evaluated by measuring increase in profitability, decrease in credit risk or fraud, etc. This module takes various inputs in the form of (models, variables, rules, challengers) creates an optimized strategy based on target objectives and constraints defined for the business that will lead to optimal gain in key business metrics. In a lending environment, for example, if one wants to control credit risk and sets an upper bound for the acceptable range, then this module would take into account all the models, business rules, test segments, etc, to generate an optimized strategy which would approve only those application whose predicted cumulative credit risk falls below this upper bound. For example, in the case of John's loan application, the decision logic comprises of a profit model score, a third party credit score and a fraud alert and a threshold may be determined based on these three values. The Decision Logic Module 108 may also trigger a rebuild (giving few constraints) of certain models that are a part of the strategy. The final decision logic (including model, IDV, and DecisionLogic specs) arrived at will be reviewed and presented in a common format (across the system) that will enable automatic deployment into the Real Time Decision Engine 101. This is a very important functionality of the AMP system and the cycle time here is very small—i.e., the time taken from identifying a profitable business strategy within the Decision Logic Module and deploying the same into the same in the Real Time Decision Engine 101 is minimal.

In an embodiment of the AMP system used for consumer credit, the Decision Logic Module 108 creates a business strategy based on constrained optimization where the objective function is (to maximize) Total Profit from the portfolio. Constraints typically are in the form of available lending capital and reserve requirements and specific conditions on metrics related to bad debt and unit profit (i.e. individual loan or customer level profit), and the inputs are the different predictive models built for each aspect of the portfolio (risk, conversion, profitability, income, etc). The business strategy typically ends up as a set of mathematical rules derived from the models that are applied to each transaction. The derived business strategy, along with the underlying predictive models and variables is then passed onto the Pre-Production Testing 109, to be eventually deployed into the Real Time Decision Engine 101.

In an embodiment of the AMP system used for fraud detection, the Decision Logic Module 108 creates a business strategy based on constrained optimization where the usual objective function is (to minimize) Loss from fraudulent transactions. Constraints typically are in the form of the (maximum allowed) number of false positives per successful detection of fraudulent transaction, and maximum decline rate. The business strategy typically ends up as a set of mathematical rules derived from the models that are applied to each transaction in real time. The derived business strategy, along with the underlying predictive models and variables is then passed onto the Pre-Production Testing 109, to be eventually deployed into the Real Time Decision Engine 101.

Each of the components in FIG. 1 may have integrity checks which may be rigorous data checks and other testing mechanisms so as to capture errors early and rectify them immediately. These integrity checks are also conducted by the Pre-production testing engine 109, which also performs end to end testing to ensure bug-free deployment After all specified testing has been successful, the Pre-Production Testing Engine 109 then deploys the corresponding variables, predictive models, challengers and business strategies obtained from the previous modules into the Real Time Decision Engine 101, completing the feedback cycle.

Each of the components in FIG. 1 also may have a logging feature in which information is logged in an organized way at every point of the AMP process. All modules have an inbuilt logging process implemented to record their working whenever they are used.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An adaptive modeling platform, comprising:
a processor and a memory;
the processor configured to receive a plurality of piece of data about a transaction;
the processor configured to generate a real-time decision based on a predictive model and the plurality of piece of data about the transaction; and
the processor configured to automatically one of build the predictive model and rebuild the predictive model in response to a plurality of pieces of data about a plurality of transactions.

2. The platform of claim 1, wherein the processor is configured to build and update one or more decision rules triggered by the plurality of pieces of data about a plurality of transactions.

3. The platform of claim 1, wherein the transaction is one of a financial industry transaction, a consumer credit transaction, a business credit transaction, a fraud detection transaction, a targeted marketing transaction, a transaction monitoring transaction, a customer care transaction and a pricing optimization transaction.

4. The platform of claim 1, wherein the processor is configured to generate decision logic for the transaction based on the plurality of piece of data about the transaction.

5. The platform of claim 1, wherein the processor is configured to automatically generate one or more variables for the predictive model based on the plurality of pieces of data about the plurality of transactions.

6. The platform of claim 1 further comprising a champion/challenger engine that generates a test segment to test in real time the predictive model.

7. The platform of claim 4 further comprising a scoring and decision module that creates, optimizes and deploys the decision logic.

8. The platform of claim 1 further comprising a report generation module that creates reports and triggering alerts based on a real time performance of the generation of the real-time decision.

9. The platform of claim 8, wherein the report generation module triggers an alert to rebuild the predictive model.

10. The platform of claim 8, wherein the report generation module triggers an alert to deploy a new predictive model.

11. The platform of claim 4 further comprising a report generation module that triggers an alert to automatically adjust the decision logic.

12. The platform of claim 4 further comprising a report generation module that triggers an alert to automatically deploy new decision logic.

13. The platform of claim 5, wherein the one or more variables are digital filter variables.

14. The platform of claim 13, wherein the one or more variables are Bayesian adjusted digital filter variables.

15. The platform of claim 1, wherein the data is one of performance data and outcome data.

16. The platform of claim 14, wherein the processor is configured to rebuild the predictive model when a new digital filter variable is created.

17. The platform of claim 4, wherein the processor is configured to rebuild the decision logic when a new digital filter variable is created.

18. The platform of claim 5, wherein the processor is configured to generates the one or more variables based on new data about the transaction.

19. The platform of claim 5 further comprising a data manager that maintains a definition and a property of the one or more variables in a common format.

20. The platform of claim 4, wherein the decision logic is a decision strategy using the predictive model, an objective and a constraint.

21. The platform of claim 20, wherein the processor is configured to automatically update the decision strategy based on new data about the transaction.

22. The platform of claim 1 further comprising a model management model that performs one of the following: monitoring the performance of the predictive model currently deployed in real time production, triggering automatic rebuilds of the predictive model based on the performance, triggering predictive model rebuilds based on time elapsed, triggering predictive model rebuilds based on new data availability, triggering predictive model rebuilds based on availability of new variables, triggering predictive model rebuilds based on statistical distribution shifts observed in the data for the transactions and triggering predictive model rebuilds based on performance of a challenger strategy.

23. The platform of claim 20 further comprising a model management model that performs one of the following: monitoring the performance of the predictive model currently deployed in real time production, triggering automatic rebuilds of the decision strategy based on the performance, triggering decision strategy rebuilds based on time elapsed, triggering decision strategy rebuilds based on new data availability, triggering decision strategy rebuilds based on availability of new variables, triggering decision strategy rebuilds based on statistical distribution shifts observed in the data for the transactions and triggering decision strategy rebuilds based on performance of a challenger strategy.

24. The platform of claim 6, wherein the champion/challenger module performs one or more of the following: monitoring the performance of deployed champion and challenger business strategies, triggering automatic distribution updates to the overall decision strategy based on performance, automatically pruning underperforming strategies based on specified performance conditions, automatically allocating higher distribution of transactions to challenger strategies that are performing well, ultimately promoting them to champion and alerting the system to trigger rebuild if any predictive model underperforms on any of the challenger segments.

25. A method for performing adaptive modeling, comprising:
receiving, at a computer having a real time decision engine, a plurality of piece of data about a transaction;
generating, by the real time decision engine, a real-time decision based on a predictive model and the plurality of piece of data about the transaction; and
automatically adjusting, by the real time decision engine, the predictive model in response to a plurality of pieces of data about a plurality of transactions.

26. The method of claim 25, wherein adjusting the predictive model further comprises one of building the predictive model and rebuilding the predictive model.

27. The method of claim 25 further comprising automatically adjusting one or more decision rules triggered by the plurality of pieces of data about a plurality of transactions.

28. The method of claim 27, wherein adjusting the decision rules further comprises one of building the decision rules and rebuilding the decision rules.

29. The method of claim 25, wherein the transaction is one of a financial industry transaction, a consumer credit transaction, a business credit transaction, a fraud detection transaction, a targeted marketing transaction, a transaction monitoring transaction, a customer care transaction and a pricing optimization transaction.

30. The method of claim 25 further comprising generating decision logic for the transaction based on the plurality of piece of data about the transaction.

31. The method of claim 25 further comprising automatically generating one or more variables for the predictive model based on the plurality of pieces of data about the plurality of transactions.

32. The method of claim 25 further comprising generating a test segment to test in real time the predictive model.

33. The method of claim 30 further comprising creating, optimizes and deploying the decision logic.

34. The method of claim 25 further comprising creating reports and triggering alerts based on a real time performance of the generation of the real-time decision.

35. The method of claim 34, wherein triggering the alerts further comprises triggering an alert to rebuild the predictive model.

36. The method of claim 34, wherein triggering the alerts further comprises triggering an alert to deploy a new predictive model.

37. The method of claim 30 further comprising triggering an alert to automatically adjust the decision logic.

38. The method of claim 30 further comprising triggering an alert to automatically deploy new decision logic.

39. The method of claim 31, wherein the one or more variables are digital filter variables.

40. The method of claim 39, wherein the one or more variables are Bayesian adjusted digital filter variables.

41. The method of claim 25, wherein the data is one of performance data and outcome data.

42. The method of claim 39 further comprising rebuilding the predictive model when a new digital filter variable is created.

43. The method of claim 30 further comprising rebuilding the decision logic when a new digital filter variable is created.

44. The method of claim 31, wherein generating the one or more variables further comprises generating the one or more variables based on new data about the transaction.

45. The method of claim 30, wherein the decision logic is a decision strategy using the predictive model, an objective and a constraint.

46. The method of claim 45 further comprising automatically updating the decision strategy based on new data about the transaction.

47. The method of claim 25 further comprising monitoring the performance of the predictive model currently deployed in real time production, triggering automatic rebuilds of the predictive model based on the performance, triggering predictive model rebuilds based on time elapsed, triggering predictive model rebuilds based on new data availability, triggering predictive model rebuilds based on availability of new variables, triggering predictive model rebuilds based on statistical distribution shifts observed in the data for the transactions and triggering predictive model rebuilds based on performance of a challenger strategy.

48. The method of claim 45 further comprising monitoring the performance of the predictive model currently deployed in real time production, triggering automatic rebuilds of the decision strategy based on the performance, triggering decision strategy rebuilds based on time elapsed, triggering decision strategy rebuilds based on new data availability, triggering decision strategy rebuilds based on availability of new variables, triggering decision strategy rebuilds based on statistical distribution shifts observed in the data for the transactions and triggering decision strategy rebuilds based on performance of a challenger strategy.

49. The method of claim 32 further comprising monitoring the performance of deployed champion and challenger business strategies, triggering automatic distribution updates to the overall decision strategy based on performance, automatically pruning underperforming strategies based on specified performance conditions, automatically allocating higher distribution of transactions to challenger strategies that are performing well, ultimately promoting them to champion and alerting the system to trigger rebuild if any predictive model underperforms on any of the challenger segments.
